(19) United States
(12) Patent Application Publication
(10) Pub. No.: US 2015/0230294 A1
(43) Pub. Date: Aug. 13, 2015

(54) INDUCTION HEATED ROLL APPARATUS AND INDUCTION COIL TEMPERATURE DETECTING MECHANISM

(71) Applicant: TOKUDEN CO., LTD., Kyoto-shi (JP)

(72) Inventors: Toru Tonomura, Otsu-shi (JP); Yasuhiro Fujimoto, Kyoto-shi (JP); Masayoshi Kimura, Otsu-shi (JP)

(21) Appl. No.: 14/617,134

(22) Filed: Feb. 9, 2015

(30) Foreign Application Priority Data
Feb. 10, 2014 (JP) 2014-023038

(51) Int. Cl. H05B 6/36; H05B 1/02

(52) U.S. Cl. CPC H05B 6/36; H05B 1/02

(57) ABSTRACT

The present invention intends to detect the temperature of an induction coil without providing a temperature sensor inside a roll main body, and includes: a DC voltage application part that controls a DC power supply to intermittently apply DC voltage to the induction coil; a resistance value calculation part that calculates a resistance value of the induction coil from the DC voltage applied by the DC voltage application part and DC current flowing through the induction coil; a relational data storage part that stores relational data indicating a resistance value versus temperature relationship between the resistance value of the induction coil and the temperature of the induction coil; and a coil temperature calculation part that calculates the temperature of the induction coil from the resistance value obtained by the resistance value calculation part and the resistance value versus temperature relationship indicated by the relational data.

### TECHNICAL FIELD

The present invention relates to an induction heated roll apparatus, and a temperature detecting mechanism adapted to detect the temperature of an induction coil of the induction heated roll apparatus.

### BACKGROUND ART

As disclosed in Patent Literature 1, an induction heated roll apparatus includes: a roll main body that is rotatably supported; and a magnetic flux generating mechanism that is provided inside the roll main body and includes an iron core and an induction coil wound around the iron core, and the induction coil is typically placed inside the roll main body. The induction coil is often heated to a high temperature by self-heating due to current application, and heat is applied to the roll main body that is inductively heated.

For this reason, in order to prevent the induction coil from being heated to a high temperature exceeding an allowable heat resistant temperature and thereby becoming burned out, a temperature sensor is generally embedded in the induction coil to monitor the temperature of the induction coil.

However, in order to electrically insulate the temperature sensor and the induction coil from each other, an insulator should be made to intervene between the temperature sensor and the induction coil, and therefore there occurs a problem in that the temperature sensor is thermally insulated by the insulator and consequently deteriorates the detection accuracy. Further, the detection accuracy also varies depending on a contact state between the temperature sensor and the induction coil, making it difficult to detect an accurate temperature. In addition, the temperature sensor often deteriorates due to temperature and disconnects due to mechanical external force, and replacing the temperature sensor involves difficulties, such as the disassembly of the induction heated roll apparatus.

### CITATION LIST

### Patent Literature

Patent Literature 1: Japanese Unexamined Patent Publication JP-A2001-155847

### SUMMARY OF INVENTION

### Technical Problem

Therefore, the present invention is made in order to solve the above-described problems, and a main intended object thereof is to detect the temperature of an induction coil without providing a temperature sensor inside a roll main body.

### Solution to Problem

That is, an induction heated roll apparatus according to the present invention is an induction heated roll apparatus including: a roll main body that is rotatably supported; and a magnetic flux generating mechanism that is provided inside the roll main body and includes an iron core and an induction coil wound around the iron core, and includes: a DC voltage application part that controls a DC power supply to intermittently apply DC voltage to the induction coil; a resistance value calculation part that calculates a resistance value of the induction coil from the DC voltage applied by the DC voltage application part and DC current flowing through the induction coil when applying the DC voltage; a relational data storage part that stores relational data indicating a resistance value versus (to) temperature relationship between the resistance value of the induction coil and temperature of the induction coil; and a coil temperature calculation part that calculates the temperature of the induction coil from the resistance value obtained by the resistance value calculation part and the resistance value versus temperature relationship indicated by the relational data.

Also, an induction coil temperature detecting mechanism according to the present invention includes: a DC voltage application part that controls a DC power supply to intermittently apply DC voltage to an induction coil of an induction heated roll apparatus; a resistance value calculation part that calculates a resistance value of the induction coil from the DC voltage applied by the DC voltage application part and DC current flowing through the induction coil when applying the DC voltage; a relational data storage part that stores relational data indicating a resistance value versus temperature relationship between the resistance value of the induction coil and temperature of the induction coil; and a coil temperature calculation part that calculates the temperature of the induction coil from the resistance value obtained by the resistance value calculation part and the resistance value versus temperature relationship indicated by the relational data.

If so, each of the induction heated roll apparatus and the induction coil temperature detecting mechanism has the induction coil temperature calculation part that calculates the temperature of the induction coil from the resistance value obtained by the resistance value calculation part and the resistance value versus temperature relationship between the resistance value of the induction coil and the temperature of the induction coil, and can therefore detect the temperature of the induction coil without providing a temperature sensor for detecting the temperature of the induction coil inside the roll main body.

The resistivity and temperature of the induction coil have a relationship approximately proportional to absolute temperature, and exhibit change characteristics specific to the material of the induction coil. For example, in the case where the wire material is copper, the relationship is given by the following expressions, and therefore if the resistance value is known, the temperature of the induction coil can be calculated.

r=kL/100S[Ω]

k=2.1(234.5+θ_{c})/309.5

Here, r is the resistance value of the induction coil [Ω], L the wire length forming the coil [m], S the wire cross-sectional area [mm²], and θ_{c} the temperature of the induction coil [° C.].

The resistance value of the induction coil can be calculated by applying a fixed DC voltage to the induction coil within a short period of time of several seconds, and dividing the DC voltage by DC current flowing through the induction coil when applying the DC voltage. Note that the DC voltage does not produce any inductive effect, and therefore the DC current is not affected by the roll main body or the iron core and has a relationship only with the resistance value of the induction coil.

Also, intermittently applying the DC voltage refers to applying the DC voltage for an application time of several seconds or less with a regular period of, for example, several seconds to several minutes. Such intermittent application can reduce a biased magnetization effect produced by a DC component, and also minimally suppress an effect on an AC circuit for induction heating. Further, in general, an induction coil of an induction heated roll apparatus has a large thermal inertia, and a change in temperature of the induction coil is not very large during operation under a normal constant load condition. Accordingly, it can be said that performing the temperature detection, which is performed for a short application time of several seconds or less, with a period of several seconds to several minutes, preferably with a period of several tens of seconds to several minutes, is sufficient for temperature control of the roll main body.

Desirably, the induction heated roll apparatus further includes a power supply circuit that is connected to the induction coil and provided with a control circuit part adapted to control AC current or AC voltage, and in a state where the control circuit part interrupts or minimizes the AC current or the AC voltage, the resistance value calculation part calculates the resistance value of the induction coil with the DC voltage being applied to the induction coil.

To detect only a DC component (DC current) from current in which AC current and DC current are superimposed as a result of applying DC voltage to the induction coil applied with AC voltage, a complicated detection circuit is required. Note that a typical induction heated roll apparatus includes a power supply circuit having a control circuit part adapted to control AC current or AC voltage for controlling the temperature of a roll main body. For this reason, by using the control circuit part to interrupt or reduce the AC current or the AC voltage to a minimum value only for the application time for applying the DC voltage, the effect of the AC current (AC component) can be suppressed to easily detect the DC current (DC component). Note that the AC current or the AC voltage is interrupted or reduced to a minimum value within a short period of time of several seconds at time intervals of several seconds to several minutes, which does not block an induction heating action.

A possible embodiment adapted to interrupt or reduce the AC current or the AC voltage to a minimum value is one adapted to, in the case where the control circuit part has a switching device such as an electromagnetic contactor, interrupt the switching device, or in the case where the control circuit part has a semiconductor element (power control element) such as a thyristor, minimize a conduction phase angle of the semiconductor element.

### Advantageous Effects of Invention

According to the present invention configured as described, the temperature of the induction coil can be detected without providing a temperature sensor inside the roll main body.

### BRIEF DESCRIPTION OF DRAWINGS

FIG. 1 is a diagram schematically illustrating a configuration of an induction heated roll apparatus according to the present embodiment; and

FIG. 2 is a functional configuration diagram of a control device in the same embodiment.

### DESCRIPTION OF EMBODIMENTS

In the following, one embodiment of an induction heated roll apparatus according to the present invention is described with reference to the drawings.

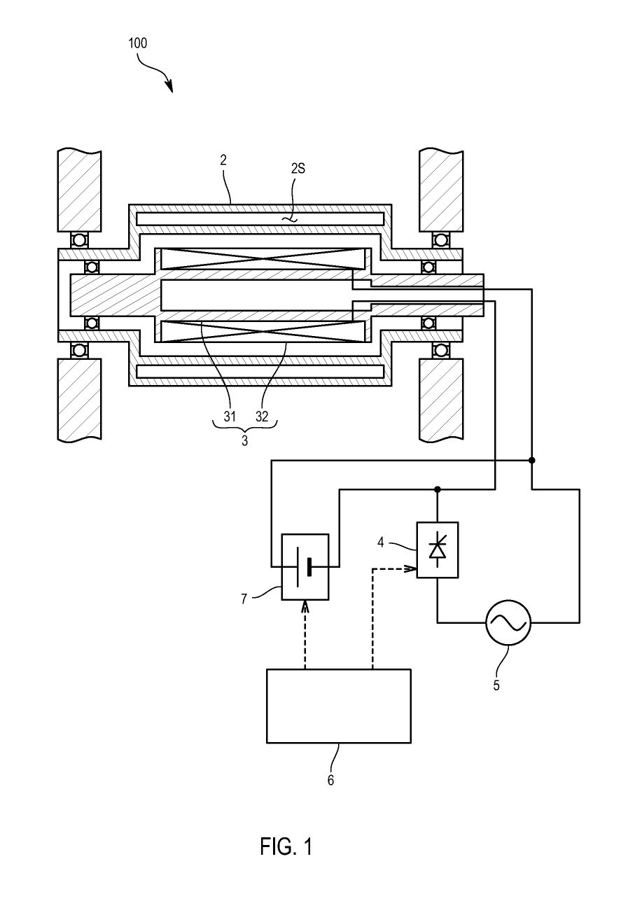

As illustrated in FIG. 1, an induction heated roll apparatus 100 according to the present embodiment includes: a roll main body 2 that is rotatably supported; a magnetic flux generating mechanism 3 that is provided inside the roll main body 2 and includes an iron core 31 and an induction coil 32 wound around the iron core 31; and a power supply circuit 5 that is connected to the induction coil 32 and provided with a control circuit part 4 adapted to control AC current or AC voltage.

Inside the lateral circumferential wall of the roll main body 2, multiple jacket chambers 2S in which a gas-liquid two-phase heating medium is included are formed at regular intervals in a circumferential direction. Also, the control circuit part 4 in the present embodiment is one that has a semiconductor element adapted to control the conduction angle of the current or the voltage, and specifically, has a thyristor. In addition, the control circuit part 4 may be one having a switching device such as an electromagnetic contactor.

The induction heated roll apparatus 100 of the present embodiment performs a temperature detecting action that periodically detects the temperature of the induction coil 32 during a heating operation that inductively heats the roll main body 2 to treat a heated object. Specifically, the induction heated roll apparatus 100 has a temperature detecting mechanism adapted to detect the temperature of the induction coil 32, and more specifically, a control device 6 that controls the induction heated roll apparatus 100 has a temperature detecting mechanism adapted to detect the temperature of the induction coil 32.

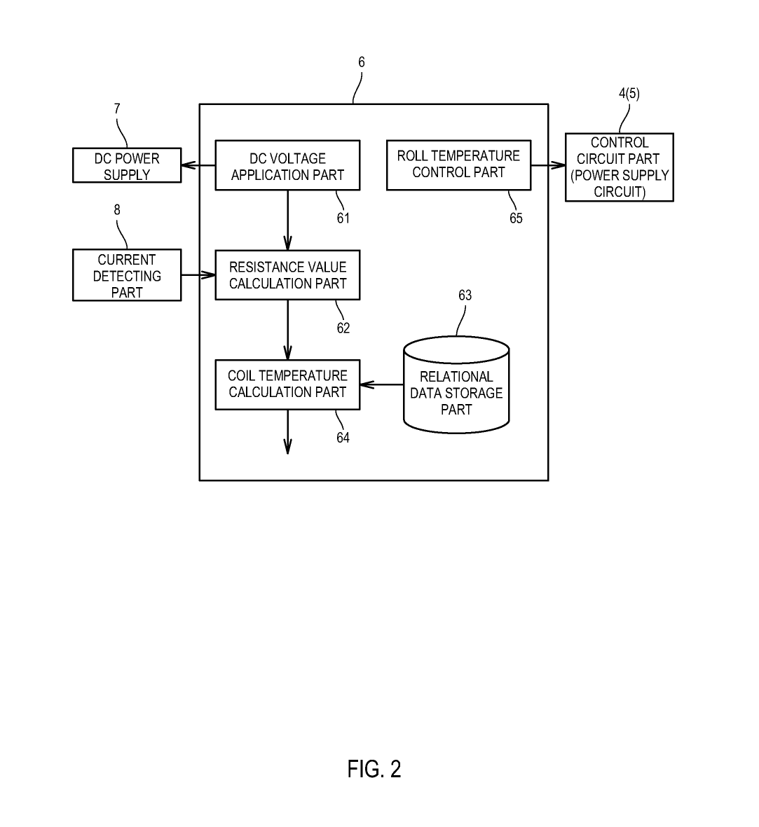

Specifically, the control device 6 is a dedicated or general-purpose computer including a CPU, an internal memory, an A/D converter, a D/A converter, an input/output interface, and the like. Also, the CPU and peripheral devices operate according to a predetermined program preliminarily stored in the internal memory, and thereby as illustrated in FIG. 2, the control device 6 fulfills functions such as a DC voltage application part 61, resistance value calculation part 62, relational data storage part 63, coil temperature calculation part 64, and the like.

The DC voltage application part 61 is one that controls a DC power supply 7 electrically connected to the induction coil 32 to intermittently apply DC voltage to the induction coil 32. Specifically, the DC voltage application part 61 is one that applies a fixed DC voltage to the induction coil 32 for an application time of several seconds or less with a regular period of several seconds to several minutes.

Note that within the application time for which the DC voltage is applied to the induction coil 32 by the DC voltage application part 61, a roll temperature control part 65 of the control device 6 controls the control circuit part 4 to interrupt or minimize the AC current or the AC voltage. In addition, the roll temperature control part 65 is one that, in order to adjust the temperature of the roll main body 2 to a predetermined setting temperature, controls the control circuit part 4 provided for the power supply circuit 5 to control the AC voltage or the AC current.

The resistance value calculation part 62 is one that calculates a resistance value of the induction coil 32 from the DC voltage applied by the DC voltage application part 61 and DC current flowing through the induction coil 32 when applying the DC voltage to the induction coil 32. Specifically, the resistance value calculation part 62 calculates the resistance value of the induction coil 32 from the DC voltage of the DC power supply 7, which is preliminarily inputted, and the DC current obtained by a current detection part 8 provided in a DC circuit configured to include the induction coil 32 and the DC power supply 7.

As described above, since at the time of applying the DC voltage and detecting the DC current, the AC current or the AC voltage is interrupted or minimized, the effect of the AC current (AC component) can be suppressed to easily detect the DC current (DC component), and therefore the resistance value can be accurately calculated.

The relational data storage part 63 stores relational data indicating a resistance value versus temperature relationship between the resistance value of the induction coil 32 and the temperature of the induction coil 32. Relational expressions representing the resistance value versus temperature relationship are, in the case where the wire material of the induction coil 32 is copper, given as follows.

r=kL/100S[Ω]

k=2.1(234.5+θ_{c})/309.5

Here, r is the resistance value of the induction coil 32 [Ω], L the wire length forming the induction coil 32 [m], S the wire cross-sectional area [mm²], and θ_{c} the temperature of the induction coil 32 [° C.].

The relational data indicating the relational expressions may be set in a predetermined area of the internal memory of the control device 6, or in a predetermined area of an external memory attached outside the control device 6.

The coil temperature calculation part 64 calculates the temperature of the induction coil 32 using the resistance value of the induction coil 32 calculated by the resistance value calculation part 62 and the relational data stored in the relational data storage part 63.

The induction heated roll apparatus 100 of the present embodiment configured as described has the coil temperature calculation part 64 that calculates the temperature of the induction coil 32 from the resistance value obtained by the resistance value calculation part 64 and the resistance value versus temperature relationship between the resistance value of the induction coil 32 and the temperature of the induction coil 32, and can therefore detect the temperature of the induction coil 32 without providing a temperature sensor for detecting the temperature of the induction coil 32 inside the roll main body 2.

Note that the present invention is not limited to the above-described embodiment.

For example, the induction heated roll of the above-described embodiment may be a so-called double-sided support induction heated roll in which both end parts of a roll main body in an axial direction are rotatably supported, or a so-called single-sided support induction heated roll in which the bottom part of a bottom-equipped tubular roll main body is connected with a rotary shaft and rotatably supported.

The present invention is not limited to any of the above-described embodiments, but can be variously modified without departing from the scope thereof.

### EXPLANATION OF REFERENCE CHARACTERS

100: Induction heated roll apparatus

2: Roll main body

3: Magnetic flux generating mechanism

31: Iron core

32: Induction coil

4: Control circuit part

5: Power supply circuit

51: AC power supply

6: Control device

61: DC voltage application part

62: Resistance value calculation part

63: Relational data storage part

64: Coil temperature calculation part

65: Roll temperature control part

7: DC power supply

1. An induction heated roll apparatus comprising: a roll main body that is rotatably supported; and a magnetic flux generating mechanism that is provided inside the roll main body and includes an iron core and an induction coil wound around the iron core, the induction heated roll apparatus comprising:
a DC voltage application part that controls a DC power supply to intermittently apply DC voltage to the induction coil;
a resistance value calculation part that calculates a resistance value of the induction coil from the DC voltage applied by the DC voltage application part and DC current flowing through the induction coil when applying the DC voltage;
a relational data storage part that stores relational data indicating a resistance value versus temperature relationship between the resistance value of the induction coil and temperature of the induction coil; and
a coil temperature calculation part that calculates the temperature of the induction coil from the resistance value obtained by the resistance value calculation part and the resistance value versus temperature relationship indicated by the relational data.

2. The induction heated roll apparatus according to claim 1, further comprising
a power supply circuit that is connected to the induction coil and provided with a control circuit part adapted to control AC current or AC voltage, wherein
in a state where the control circuit part interrupts or minimizes the AC current or the AC voltage, the resistance value calculation part calculates the resistance value of the induction coil with the DC voltage being applied to the induction coil.

3. An induction coil temperature detecting mechanism comprising:
a DC voltage application part that controls a DC power supply to intermittently apply DC voltage to an induction coil of an induction heated roll apparatus;
a resistance value calculation part that calculates a resistance value of the induction coil from the DC voltage applied by the DC voltage application part and DC current flowing through the induction coil when applying the DC voltage;
a relational data storage part that stores relational data indicating a resistance value versus temperature relationship between the resistance value of the induction coil and temperature of the induction coil; and
a coil temperature calculation part that calculates the temperature of the induction coil from the resistance value obtained by the resistance value calculation part and the resistance value versus temperature relationship indicated by the relational data.
